(19) United States
(12) Patent Application Publication
(10) Pub. No.: US 2020/0125945 A1
(43) Pub. Date: Apr. 23, 2020

(54) AUTOMATED HYPER-PARAMETERIZATION FOR IMAGE-BASED DEEP MODEL LEARNING

(71) Applicant: DRVision Technologies LLC, Bellevue, WA (US)

(72) Inventors: Shih-Jong James Lee, Bellevue, WA (US); Hideki Sasaki, Bellevue, WA (US); Luciano Andre Guerreiro Lucas, Redmond, WA (US)

(21) Appl. No.: 16/164,672

(22) Filed: Oct. 18, 2018

(51) Int. Cl. G06N 3/08; G06N 3/04; G06F 15/18; G06K 9/62

(52) U.S. Cl. CPC G06N 3/08; G06K 9/6256; G06F 15/18; G06N 3/0454

(57) ABSTRACT

A computerized method of automated hyper-parameterization for image-based deep model learning performs a deep model setup learning using initial learning images, initial truth data and a hyper-parameter setup recipe to generate deep model setup parameters, then performs a deep model learning using learning images, truth data and the generated deep model setup parameters to generate a deep model. Alternatively, the deep model learning may be a guided deep model learning. The deep model setup learning performs a deep model application, a deep quantifier calculation, and a salient hyper-parameter prediction. The hyper-parameter setup recipe may be generated by performing (a) a deep hyper-parameter mapping using application-specific learning images and application-specific truth data, (b) a salient hyper-parameter extraction, (c) a deep quantifier generation, and (d) a salient hyper-parameter prediction learning.

### STATEMENT AS TO RIGHTS TO INVENTIONS MADE UNDER FEDERALLY SPONSORED RESEARCH AND DEVELOPMENT

This work was supported by U.S. Government grant number 5R44NS097094-03, awarded by the NATIONAL INSTITUTE OF NEUROLOGICAL DISORDERS AND STROKE. The U.S. Government may have certain rights in the invention.

### BACKGROUND OF THE INVENTION

### Field of the Invention

The present invention relates to image-based deep model learning. More particularly, the present invention relates to computerized methods of automated hyper-parameterization for image-based deep model learning.

### Description of the Related Art

a. Description of Problem that Motivated Invention

Model optimization is one of the toughest challenges in the implementation of machine learning solutions. Tuning machine learning hyper-parameters is a tedious yet crucial task, as the performance of a model can be highly dependent on the choice of hyper-parameters. There are well established hyper-parameters such as the number of hidden units or the learning rate of a model, but there are also an arbitrary number of settings that can play the role of hyper-parameters for specific models. In general, hyper-parameters are very specific to the type of machine learning model that one is trying to optimize. Sometimes, a setting is modeled as a hyper-parameter because it is not appropriate to learn it from the training set. A classic example is settings that control the capacity of a model (i.e. the spectrum of functions that the model can represent). If a deep learning algorithm learns those settings directly from the training set, it is likely to try to optimize for that dataset which will cause the model to overfit (namely, poor generalization).

The difficulty in machine learning model optimization has prevented the broad use of machine learning solutions by non-expert users. For example, machine learning could be a great tool to revolutionize the fields of bioscience image analysis and phenotype discoveries, yet the adoption is slow mainly due to the difficulty in model optimization for user-specific data and requirements. There is an urgent need for an automated hyper-parameterization method that is user friendly and efficient so as to facilitate the broad adoption of machine learning technologies in different fields of applications.

b. How did Prior Art Solve Problem?

One entire branch of machine learning and deep learning theory has been dedicated to the optimization of models. Model optimization is a process of regularly modifying the model in order to minimize the testing error. However, deep learning optimization often entails fine tuning elements that live outside the model but that can heavily influence its behavior.

Optimizing hyper-parameter manually can be an exhausting endeavor. To address that challenge, one can use algorithms that automatically infer a potential set of hyper-parameters and attempt to optimize them while hiding that complexity from the developer. Algorithms such as Grid Search and Random Search have become prominent when it comes to hyper-parameter inference and optimization.

Most deep learning frameworks such as TensorFlow or Keras natively include hyper-parameters optimization algorithms. However, the process of optimizing hyper-parameters in real world deep learning scenarios requires advanced tooling that can help developers conduct different experiments and track the results. Most deep learning platforms in the market include some basic form of hyper-parameter optimization but many of them are still quite limited. Here are some hyper-parameter optimization tools that are available:

SageMaker

SageMaker incorporates the creation of hyper-parameter tuning jobs directly in the SageMaker console. The platform performs the evaluation and comparison of the different hyper-parameter models and directly integrates with the training jobs and other aspects of the model lifecycle.

Comet.ml

Comet.ml provides a super simple interface for the tuning and optimization of hyper-parameters across different deep learning frameworks such as TensorFlow, Keras, PyTorch, Scikit-Learn and many others. Developers can seamlessly integrate Comet.ml into their models using the several SDKs available with the platform as well as the REST API. The platform provides a very visual way to tune and evaluate hyper-parameters.

Weights & Biases

Weights & Biases(W&B) provides an advanced toolset and programming model for recording and tuning hyper-parameters across different experiments. The solution records and visualizes the different steps in the execution of the model and correlates it with the configuration of its hyper-parameters

DeepCognition

DeepCognition enables the implementation, training and optimization of deep learning models with minimum coding. As part of the optimization process, DeepCognition includes a very powerful and visual hyper-parameter tuning engine that records and compares the execution of experiments based on specific hyper-parameter configurations.

Azure ML Azure ML provides native hyper-parameter tuning capabilities as part of its ML Studio. While the existing functionality seems limited compared to some of the other options covered in this article, the platform is able to record and provide basic visualizations relevant to the model hyper-parameters. The hyper-parameter tuning capabilities of Azure ML can be combined with other services such as Azure ML Experimentation to streamline the creation and testing of new experiments.

Cloud ML

Just like AWS SageMaker and Azure ML, Google Cloud ML provides some basic hyper-parameter tuning capabilities as part of its platform. The current Cloud ML feature set is a bit limited compared to some of its competitors but Google has proven its ability to iterate faster in this space.

However, these tools are still too inefficient and limited to be broadly adopted in different fields of applications.

### BRIEF SUMMARY OF THE INVENTION

### a. Objectives of the Invention

The primary objective of the invention is to provide a user friendly and efficient framework for a user to easily adopt machine learning for his or her applications. The secondary objective of the invention is to provide an automated hyper-parameterization for image-based deep model learning. The third objective of the invention is to provide an image-guided deep model learning method. The fourth objective of the invention is to provide an automated hyper-parameter setup recipe generation method.

### b. How does this Invention Solve the Problem?

Despite the complexity of hyper-parameter optimization, many of the hyper-parameters will not make much difference to the model performance for a specific-application. The current invention takes advantage of the application-specific information to simplify the hyper-parameter optimization process for a given application.

The current invention creates pre-trained application-specific reference models that are optimized for specific applications. An application-specific reference model is trained with representative data of the given application. To automatically optimize the models for users' data, the application-specific reference model is applied to users' application data. Based on the results of the users' data processed by the reference model, the current invention automatically generates the optimal model hyper-parameters. The optimal model hyper-parameters are used for deep model learning of users' application data. The learning could be a transfer learning started from the application-specific reference model or it could be a completely new learning starting from scratch. The current invention further provides guided model generation that monitors the learning process using not only training monitor data but also intermediate result images for learning readiness check to assure the learned deep model is close to optimal and the learning process is efficient.

### BRIEF DESCRIPTION OF THE DRAWINGS

FIG. 1 shows the processing flow of the automated method of hyper-parameterization for image-based deep model learning according to the present application.

FIG. 2 shows the processing flow of one embodiment of the deep model setup learning.

FIG. 3 shows the processing flow of one embodiment of the guided deep model learning.

FIG. 4 shows the processing flow of one embodiment of the hyper-parameter setup recipe generation.

FIG. 5 shows the processing flow of one embodiment of the learning readiness check.

FIG. 6 shows the processing flow of one embodiment of the salient hyper-parameter extraction.

FIG. 7 shows the processing flow of one embodiment of the deep quantifier generation.

### DETAILED DESCRIPTION OF THE PREFERRED EMBODIMENTS

The concepts and the preferred embodiments of the present invention will be described in detail in the following in conjunction with the accompanying drawings.

### I. Automated Hyper-Parameterization for Image-Based Deep Model Learning

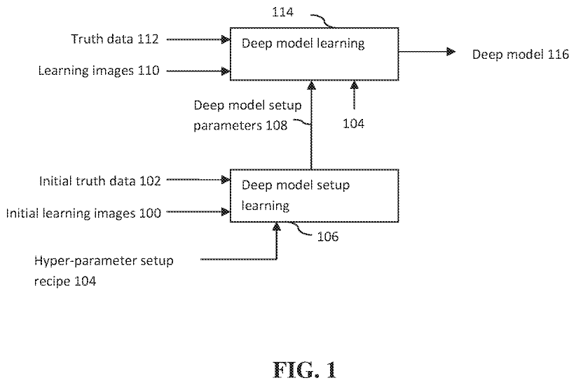

FIG.1 shows the processing flow of the automated hyper-parameterization for image-based deep model learning method of the current invention. The initial learning images 100 and their corresponding initial truth data 102 as well as the application-specific hyper-parameter setup recipe 104 are entered into electronic storage means such as computer memories. The deep model setup learning 106 is performed by computing means using the initial learning images 100, the initial truth data 102 and the hyper-parameter setup recipe 104 to generate deep model setup parameters 108. The computing means includes Central Processing Unit (CPU), Graphics Processing Unit (GPU), Digital Signal Processor (DSP) from local or cloud based platforms and/or mobile devices. The available learning images 110 and their corresponding truth data 112 are also entered into electronic storage means such as computer memories. The deep model learning 114 is performed by computing means using the learning images 110, the truth data 112, the generated deep model setup parameters 108 and the hyper-parameter setup recipe 104 to generate a deep model 116 for the application. The deep model setup learning 106 allows automatic or semi-automatic (with optional human manual fine-tune adjustment) generation of application-specific deep model setup parameters 108. This enables efficient deep model learning 114 for a user using his/her own images 100, 110 and truth data 102, 112 without expert knowledge of deep learning details and hyper-parameters and their optimization.

The current invention covers a broad range of deep model 116 containing multiple layers of artificial neural networks such as convolutional deep neural networks (CNNs), recurrent neural networks (RNNs), generative adversarial networks (GANs) and their variants such as Unet, ResUNet, DenseUNet, Bidirectional LSTM, Ensemble DNN/CNN/RNN, Hierarchical Convolutional Deep Maxout Network, etc. The image-based applications are broad, including image restoration, image prediction, image recognition, visual art processing, etc. Those skilled in the art should recognize that in addition to deep models, a variety of supervised machine learning classifier such as random forest, support vector machine, or binary decision trees, can be covered by the automated hyper-parameterization and the applications could cover the processing of non-image signals such as speech recognition, natural language processing, drug discovery and toxicology, bioinformatics financial fraud detection, etc.

The deep model learning 114 could be a transfer learning or a completely new model learning from scratch using the learning image 110, truth data 112 and the deep model setup parameters 108.

II. Deep Model Setup Learning

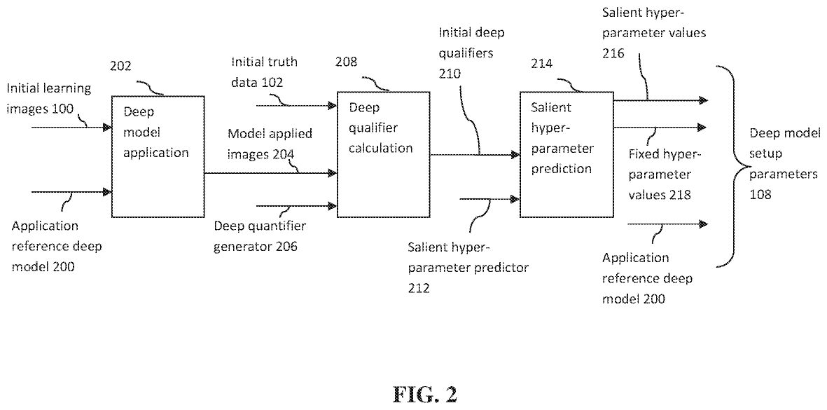

In one embodiment of the invention, the hyper-parameter setup recipe 104 consists of an application reference deep model 200, a deep quantifier generator 206 and a salient hyper-parameter predictor 212 (see FIG. 2). FIG. 2 shows the processing flow of one embodiment of the deep model setup learning 106. A deep model application 202 is performed by computing means using the initial learning images 100 and the application reference deep model 200 to generate model applied images 204. The application reference deep model 200 is a pre-trained model that is created using representative images for the specific application. The application reference deep model 200 is expected to perform well when the user's images 100, 110 match the representative images for the specific application. However, if the user's images 100, 110 do not match the training images for the application reference deep model 200, an extensive deep model learning 114 will be necessary using the deep model setup parameters 108 determined by the deep model setup learning 106. The closeness of the match between the reference deep model 200 and the initial learning images 100 are determined based on the model applied images 204.

To evaluate the closeness of the match, a deep quantifier calculation 208 is performed by computing means using the initial truth data 102, the model applied images 204 and the deep quantifier generator 206 to generate initial deep quantifiers 210. The deep qualifiers are measurements that quantify the model matching closeness. In addition to the standard error rates estimated between the initial truth data 102 and the model applied images 204, the deep quantifiers can be derived from image-based measurements such as image intensities, contrasts, textures, edges, and low to high order intensity profiles and their histograms in the error and correct regions on individual image or a group of images. The specific quantifiers to be generated are application dependent and are specified in the input deep quantifier generator 206.

A salient hyper-parameter prediction 214 is performed by computing means using the generated initial deep quantifiers 210 and the input application-specific salient hyper-parameter predictor 212 to generate the salient hyper-parameter values 216 and the fixed hyper-parameter values 218. The salient hyper-parameter values 216, the fixed hyper-parameter values 218 together with the application reference deep model 200 form the deep model setup parameters 108.

In one embodiment of the invention, the deep model setup parameters 108 are further fine-tuned and adjusted manually before applying to deep model learning 114. Furthermore, users could decide whether the deep model learning 114 should be a transfer learning based on the input application reference deep model 200, or a completely new learning from scratch using the learning images 110, the truth data 112 and the deep model setup parameters 108. The decision depends on how close the matches are between the application reference deep model 200 and the learning images 110. It also depends on the sufficiency of the learning images 110 and the truth data 112 as well as the available computing power for the learning choice.

III. Guided Deep Model Learning

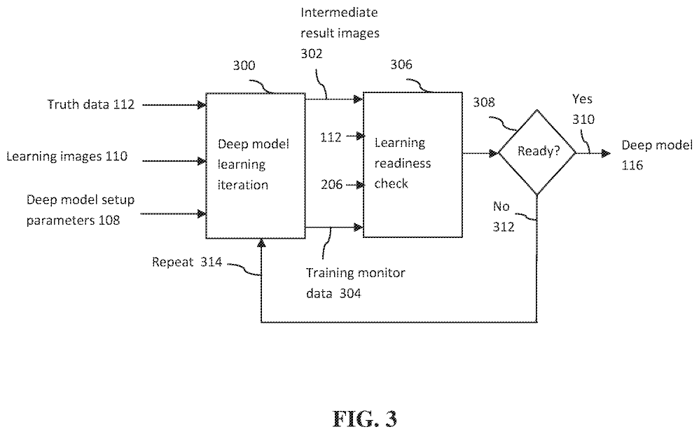

In one embodiment of the invention, the deep model learning 114 is performed by a guided deep model learning method. FIG. 3 shows the processing flow of the embodiment of the guided deep model learning. A deep model learning iteration 300 is performed by computing means using the learning image 110, the truth data 112 and the deep model setup parameters 108 to generate the intermediate result images 302 and the training monitor data 304. The deep model setup parameters 108 are used to configure the deep model such as the activation functions, the number of hidden units and layers, the number of features in each layer, the convolution kernel width, upsampling methods (nearest neighbor, transposed convolution, subpixel convolution), dropout layers, etc. It also defines the learning hyper-parameters such as weight initialization, learning rates, loss functions and the number of epochs per deep model learning iteration. The intermediate result images 302 contain the images tested after the current learning iteration. The training monitor data 304 include the data that are used to monitor training maturity. In one embodiment of the invention, the training monitor data 304 includes the training and validation loss profiles vs. the number of epochs.

A learning readiness check 306 is performed by computing means using the intermediate result images 302, the training monitor data 304, the truth data 112 and deep quantifier generator 206 contained in the deep model setup parameters 108 to generate a ready status 308. If the ready status is yes 310, the deep model 116 is outputted and the deep model learning 114 is successfully completed. If the ready status is no 312, the deep model learning iteration 300 and the learning readiness check 306 will be repeated.

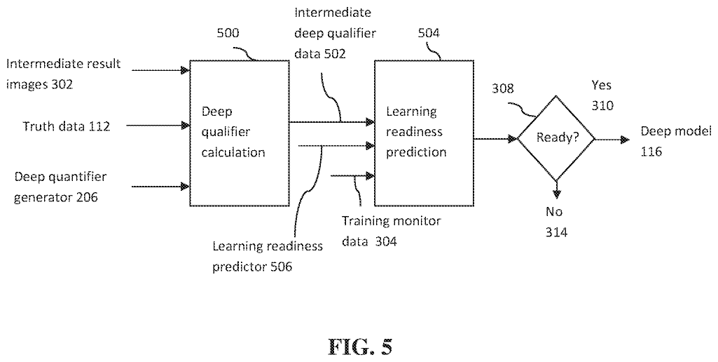

In one embodiment of the invention, the processing flow of the learning readiness check 306 is shown in FIG. 5. A deep qualifier calculation 500 is performed by computing means using the intermediate result images 302, the truth data 112 and the deep quantifier generator 206 to generate intermediate deep quantifier data 502. The intermediate deep quantifier data 502 contains measurements that quantify the goodness of the generated model. In addition to the standard error rates estimated between the truth data 112 and the intermediate result images 302, the intermediate deep quantifier data 502 can be derived from image-based measurements such as image intensities, contrasts, textures, edges, and low to high order intensity profiles and their histograms in the error and correct regions on individual image or a group of images. The specific quantifiers to be generated are application dependent and are specified in the deep quantifier generator 206. In one embodiment of the invention, the deep quantifier generator 206 can be learned using the method described in section IV.4 Deep quantifier generation.

A learning readiness prediction 504 is performed by computing means using the intermediate deep quantifier data 502, the training monitor data 304 and a learning readiness predictor 506 contained in the deep model setup parameters 108 derived from the hyper-parameter setup recipe 104 to generate the ready status 308. The learning readiness predictor 506 is a pre-trained application-specific classifier that performs status classification using the intermediate deep quantifier data 502 and the training monitor data 304. In one embodiment of the invention, the classifier is a random forest classifier. Those skilled in the art should recognize that other supervised machine learning classifiers such as support vector machine, artificial neural networks and binary decision trees can be used. In another embodiment of the invention, the teachable pattern scoring method (U.S. Pat. No. 9,152,884) is used for the supervised machine learning. In a third embodiment of the invention, the method described in the regulation of hierarchic decisions in intelligent systems (U.S. Pat. No. 7,031,948) is used for the supervised machine learning.

IV. Hyper-Parameter Setup Recipe

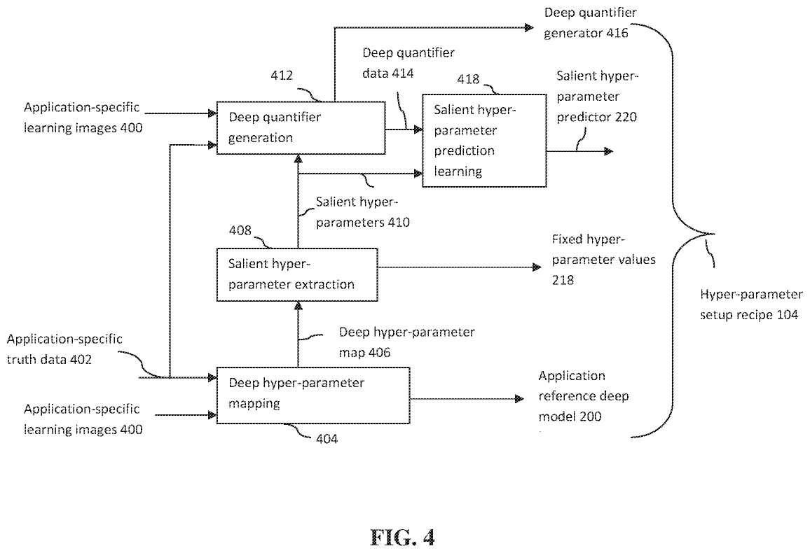

For a specific-application, the hyper-parameter setup recipe 104 can be pre-generated and be used as input for new users of the same or similar applications. FIG. 4 shows the processing flow of one embodiment of the hyper-parameter setup recipe generation. Application-specific learning images 400 and application-specific truth data 402 are entered into electronic storage means such as computer memories. A deep hyper-parameter mapping 404 is performed by computing means using the application-specific learning images 400 and the application-specific truth data 402 to generate a deep hyper-parameter map 406 and an application reference deep model 200. A salient hyper-parameter extraction 408 is performed by computing means using the deep hyper-parameter map 406 to generate salient hyper-parameters 410 and fixed hyper-parameter values 218. A deep quantifier generation 412 is performed by computing means using the application-specific learning images 400, the application-specific truth data 402 and the salient hyper-parameters 410 to generate a deep quantifier generator 416 and deep quantifier data 414. Finally, a salient hyper-parameter prediction learning 418 is performed by computing means using the salient hyper-parameters 410 and the deep quantifier data 414 to generate a salient hyper-parameter predictor 220.

In one embodiment of the invention, the deep quantifier generator 416, the salient hyper-parameter predictor 220, the fixed hyper-parameter values 218 and the application reference deep model 200 together form the hyper-parameter setup recipe 104.

IV.1 Hyper-Parameters

In one embodiment of the invention, the hyper-parameters include parameters for pre-processing such as image normalization, correction and transformation as well as learning image augmentation. The hyper-parameters could also include model architecture parameters such as the activation functions, the number of hidden units and layers, the number of features in each layer, the convolution kernel width, the upsampling methods (nearest neighbor, transposed convolution, subpixel convolution), dropout layers, etc. The hyper-parameters could also include learning hyper-parameters such as weight initialization, learning rates, loss functions, momentum, and the number of epochs per deep model learning iteration, etc.

IV.2 Deep Hyper-Parameter Mapping

The deep hyper-parameter mapping 404 maps an objective value related to network performance metrics such as accuracy, error rates, complexity, etc. under different hyper-parameters combinations. Since possible hyper-parameter combination could cover a huge multi-dimensional space which grows exponentially in size with the number of parameters, that is the curse of dimensionality. Yet it is well known that for a specific application, many of the hyper-parameters can be fixed at default values or within tight ranges. This greatly reduced the hyper-parameter combination and the computational requirements for mapping to generate the deep hyper-parameter map 406. After the mapping, the deep model generated with the optimal hyper-parameter combination is the application reference deep model 200.

In one embodiment of the invention, Bayesian optimization (see Thornton, Chris; Hutter, Frank; Hoos, Holger; Leyton-Brown, Kevin (2013). “Auto-WEKA: Combined selection and hyper-parameter optimization of classification algorithms”) is used for the deep hyper-parameter mapping 404. Bayesian optimization is a global optimization method for noisy black-box functions. Bayesian optimization builds a probabilistic model of the function mapping from hyper-parameter values to the objective values evaluated on a validation set. By iteratively evaluating a promising hyper-parameter configuration based on the current model, and then updating it, Bayesian optimization, aims to gather observations revealing as much information as possible about this function and, in particular, the location of the optimum. It tries to balance exploration (hyper-parameters for which the outcome is most uncertain) and exploitation (hyper-parameters expected close to the optimum).

Those skilled in the art should recognize that other hyper-parameter optimization/mapping methods such as grid search, random search, gradient-based optimization and evolutionary optimization could be used for deep hyper-parameter mapping 404.

IV.3 Salient Hyper-Parameter Extraction

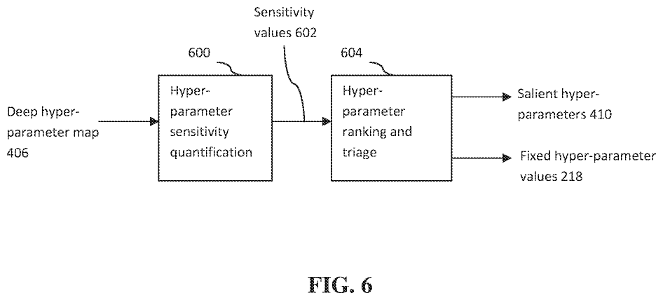

FIG. 6 shows the processing flow of one embodiment of the salient hyper-parameter extraction 408. A hyper-parameter sensitivity quantification 600 is performed by computing means using the deep hyper-parameter map 406 to generate sensitivity values 602. A hyper-parameter ranking and triage 604 is performed by computing means using the sensitivity values 602 to generate the salient hyper-parameters 410 and the fixed hyper-parameter values 218.

The hyper-parameter sensitivity quantification 600 performs sensitivity analysis of the hyper-parameters included in the deep hyper-parameter map 406. Sensitivity analysis evaluates how much each hyper-parameter is contributing to the model objective values. It can order the hyper-parameters by their strength and relevance in determining the model objective values. In one embodiment of the invention, Emulators are used for the sensitivity analysis. The approach builds a relatively simple mathematical function, known as an emulator, that approximates the input/output behavior of the deep hyper-parameter map 406. The sensitivity values 602 can be calculated from the emulator (either with Monte Carlo or analytically). In this approach, the number of model runs required to fit the emulator can be orders of magnitude less than the number of runs required to directly estimate the sensitivity values 602 from the deep hyper-parameter map 406. (See Oakley, J.; O'Hagan, A. (2004). “Probabilistic sensitivity analysis of complex models: a Bayesian approach”. J. Royal Stat. Soc. B. 66: 751-769.)

The hyper-parameter ranking and triage 604 step ranks the sensitivity values 602 and selects the hyper-parameters correspond to high rank sensitivity values and determines their parameter ranges as well as optimal values and outputs them as the salient hyper-parameters 410. The remaining hyper-parameters and their optimal values are included in the fixed hyper-parameter values 218.

IV.4 Deep Quantifier Generation

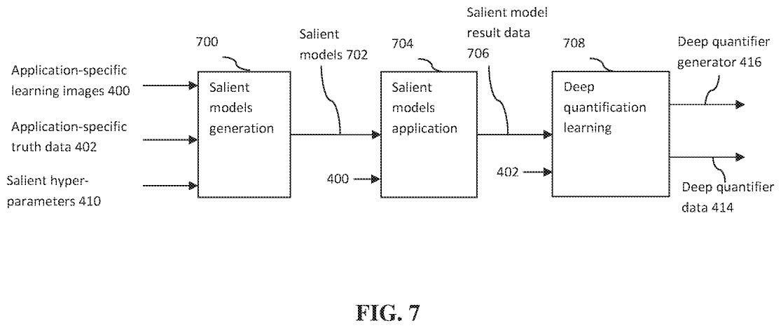

FIG. 7 shows the processing flow of one embodiment of the deep quantifier generation 412. A salient models generation 700 is performed by computing means using the application-specific learning images 400, the application-specific truth data 402 and the salient hyper-parameters 410 to generate salient models 702. The generated salient models 702 and the application-specific learning images 400 are used by a salient models application 704 to generate salient model result data 706 by computing means. A deep quantification learning 708 is performed by computing means using the salient model result data 706 and the application-specific truth data 402 to generate the deep quantifier generator 416 and the deep quantifier data 414.

The salient models generation 700 step generates a group of salient models by machine learning using the hyper-parameter settings covering the ranges of salient hyper-parameters. The output salient models 702 include the generated models as well as their associated hyper-parameter values and the optimal hyper-parameter values. The deep quantification learning 708 first calculates a set of deep quantification measurements that quantify the goodness of the salient models 702 using the salient models results data 706. In addition to the standard error rates estimated between the truth data 402 and the salient models results data 706, the deep quantification measurements can be derived from image-based measurements such as image intensities, contrasts, textures, edges, and low to high order intensity profiles and their histograms in the error and correct regions on individual image or a group of images. The deep quantification measurements that have the best prediction power to predict the deviation between the associated hyper-parameter values and their optimal values are selected for deep quantifier generation. The prediction measurements can be learned by a supervised machine learning method that learns a function that maps an input to an output based on example input-output pairs. In one embodiment of the invention, random forest is used to learn the importance of the measurements for the prediction. The measurements with the highest importance are included in the specification of the deep quantifier generator 416 and the measurements associated with the salient models results data 706 are included in the deep quantifier data 414. Those skilled in the art should recognize that other supervised learning methods such as support vector machine, binary decision trees, deep learning models can be used for the deep quantification learning 708.

IV.5 Salient Hyper-Parameter Prediction Learning

The salient hyper-parameter prediction learning 418 can be performed by a supervised machine learning classifier such as random forest, support vector machine, binary decision trees, deep learning models using the deep quantifier data 414 and associated hyper-parameters 410 to generate salient hyper-parameter predictor 220. The salient hyper-parameter predictor 220 predicts the optimal hyper-parameters from the deep quantifier data 414. In an embodiment of the invention, the teachable pattern scoring method (U.S. Pat. No. 9,152,884) is used for the salient hyper-parameter prediction learning 418. In another embodiment of the invention, the method described in the regulation of hierarchic decisions in intelligent systems (U.S. Pat. No. 7,031,948) is used for the salient hyper-parameter prediction learning 418.

The invention has been described herein in considerable detail in order to comply with the Patent Statutes and to provide those skilled in the art with the information needed to apply the novel methods and to construct and use such specialized components as are required. However, it is to be understood that the inventions can be carried out by specifically different equipment and devices, and that various modifications, both as to the equipment details and operating procedures, can be accomplished without departing from the scope of the invention itself.

What is claimed is:

1. A computerized method of automated hyper-parameterization for image-based deep model learning, the method comprising the steps of:
a) inputting initial learning images, initial truth data and a hyper-parameter setup recipe into electronic storage means;
b) performing a deep model setup learning by computing means using the initial learning images, the initial truth data and the hyper-parameter setup recipe to generate deep model setup parameters;
c) inputting learning images and truth data into electronic storage means; and
d) performing a deep model learning by computing means using the learning images, the truth data, the deep model setup parameters and the hyper-parameter setup recipe to generate a deep model.

2. The computerized method of automated hyper-parameterization for image-based deep model learning of claim 1, wherein the hyper-parameter setup recipe sets up hyper-parameters that are selected from a group consisting of (1) pre-processing parameters, (2) model architecture parameters, and (3) learning parameters.

3. The computerized method of automated hyper-parameterization for image-based deep model learning of claim 1, wherein the hyper-parameter setup recipe includes an application reference deep model, a deep quantifier generator and a salient hyper-parameter predictor, and wherein the deep model setup learning comprises the steps of:
a) performing a deep model application by computing means using the initial learning images and the application reference deep model to generate model applied images;
b) performing a deep quantifier calculation by computing means using the initial truth data, the model applied images and the deep quantifier generator to generate initial deep quantifiers; and
c) performing a salient hyper-parameter prediction by computing means using the initial deep quantifiers and the salient hyper-parameter predictor to generate the deep model setup parameters including salient hyper-parameter values, fixed hyper-parameter values and the application reference deep model.

4. The computerized method of automated hyper-parameterization for image-based deep model learning of claim 1, wherein the deep model learning is a guided deep model learning that comprises the steps of:
a) performing a deep model learning iteration by computing means using the learning image, the truth data and the deep model setup parameters to generate intermediate result images and training monitor data;
b) performing a learning readiness check by computing means using the intermediate result images, the training monitor data, the truth data and a deep quantifier generator contained in the hyper-parameter setup recipe to generate a ready status;
c) if the ready status is yes, outputting the deep model; and
d) if the ready status is no, repeating the steps a) and b).

5. The computerized method of automated hyper-parameterization for image-based deep model learning of claim 1, wherein the hyper-parameter setup recipe is generated by the steps of:
a) inputting application-specific learning images and application-specific truth data into electronic storage means;
b) performing a deep hyper-parameter mapping by computing means using the application-specific learning images and the application-specific truth data to generate a deep hyper-parameter map and an application reference deep model;
c) performing a salient hyper-parameter extraction by computing means using the deep hyper-parameter map to generate salient hyper-parameters and fixed hyper-parameter values;
d) performing a deep quantifier generation by computing means using the application-specific learning images, the application-specific truth data and the salient hyper-parameters to generate a deep quantifier generator and deep quantifier data; and
e) performing a salient hyper-parameter prediction learning by computing means using the salient hyper-parameters and the deep quantifier data to generate a salient hyper-parameter predictor.

6. The computerized method of automated hyper-parameterization for image-based deep model learning of claim 1, wherein the deep model setup parameters generated by the deep model setup learning are further fine-tuned and adjusted manually.

7. The computerized method of automated hyper-parameterization for image-based deep model learning of claim 4, wherein the learning readiness check performed in the guided deep model learning comprises the steps of:
a) performing a deep qualifier calculation by computing means using the intermediate result images, the truth data and the deep quantifier generator to generate intermediate deep quantifier data; and
b) performing a learning readiness prediction by computing means using the intermediate deep quantifier data, the training monitor data and a learning readiness predictor contained in the deep model setup parameters to generate the ready status.

8. The computerized method of automated hyper-parameterization for image-based deep model learning of claim 5, wherein the salient hyper-parameter extraction comprises the steps of:
a) performing a hyper-parameter sensitivity quantification by computing means using the deep hyper-parameter map to generate sensitivity values; and
b) performing a hyper-parameter ranking and triage by computing means using the sensitivity values to generate the salient hyper-parameters and the fixed hyper-parameter values.

9. The computerized method of automated hyper-parameterization for image-based deep model learning of claim 5, wherein the deep quantifier generation comprises the steps of:
a) performing a salient models generation by computing means using the application-specific learning images, the application-specific truth data and the salient hyper-parameters to generate salient models;
b) performing a salient models application by computing means using the salient models and the application-specific learning images to generate salient model result data; and
c) performing a deep quantification learning by computing means using the salient model result data and the application-specific truth data to generate the deep quantifier generator and the deep quantifier data.

10. A computerized automated method of hyper-parameterization for image guided deep model learning, the method comprising the steps of:
a) inputting initial learning images, initial truth data and a hyper-parameter setup recipe into electronic storage means;
b) performing a deep model setup learning by computing means using the initial learning images, the initial truth data and the hyper-parameter setup recipe to generate deep model setup parameters;
c) inputting learning images and truth data into electronic storage means; and
d) performing a guided deep model learning by computing means using the learning images, the truth data, the deep model setup parameters and the hyper-parameter setup recipe to generate a deep model.

11. The computerized method of automated hyper-parameterization for image guided deep model learning of claim 10, wherein the hyper-parameter setup recipe sets up hyper-parameters selected from a group consisting of (1) pre-processing parameters, (2) model architecture parameters, and (3) learning parameters.

12. The computerized method of automated hyper-parameterization for image guided deep model learning of claim 10, wherein the hyper-parameter setup recipe includes an application reference deep model, a deep quantifier generator and a salient hyper-parameter predictor, and wherein the deep model setup learning comprises the steps of:
a) performing a deep model application by computing means using the initial learning images and the application reference deep model to generate model applied images;
b) performing a deep quantifier calculation by computing means using the initial truth data, the model applied images and the deep quantifier generator to generate initial deep quantifiers; and
c) performing a salient hyper-parameter prediction by computing means using the initial deep quantifiers and the salient hyper-parameter predictor to generate the deep model setup parameters including salient hyper-parameter values, fixed hyper-parameter values and the application reference deep model.

13. The computerized method of automated hyper-parameterization for image guided deep model learning of claim 10, wherein the guided deep model learning comprises the steps of:
a) performing a deep model learning iteration by computing means using the learning image, the truth data and the deep model setup parameters to generate intermediate result images and training monitor data;
b) performing a learning readiness check by computing means using the intermediate result images, the training monitor data, the truth data and a deep quantifier generator contained in the hyper-parameter setup recipe to generate a ready status;
c) if the ready status is yes, outputting the deep model; and
d) if the ready status is no, repeating the steps a) and b).

14. The computerized method of automated hyper-parameterization for image guided deep model learning of claim 13, wherein the learning readiness check comprises the steps of:
a) performing a deep qualifier calculation by computing means using the intermediate result images, the truth data and the deep quantifier generator to generate intermediate deep quantifier data; and
b) performing a learning readiness prediction by computing means using the intermediate deep quantifier data, the training monitor data and a learning readiness predictor contained in the deep model setup parameters to generate the ready status.

15. A computerized hyper-parameter setup recipe generation method, comprising the steps of:
a) inputting application-specific learning images and application-specific truth data into electronic storage means;
b) performing a deep hyper-parameter mapping by computing means using the application-specific learning images and the application-specific truth data to generate a deep hyper-parameter map and an application reference deep model;
c) performing a salient hyper-parameter extraction by computing means using the deep hyper-parameter map to generate salient hyper-parameters and fixed hyper-parameter values;
d) performing a deep quantifier generation by computing means using the application-specific learning images, the application-specific truth data and the salient hyper-parameters to generate a deep quantifier generator and deep quantifier data; and
e) performing a salient hyper-parameter prediction learning by computing means using the salient hyper-parameters and the deep quantifier data to generate a salient hyper-parameter predictor.

16. The hyper-parameter setup recipe generation method of claim 15, wherein the salient hyper-parameter extraction comprises the steps of:
a) performing a hyper-parameter sensitivity quantification by computing means using the deep hyper-parameter map to generate sensitivity values; and
b) performing a hyper-parameter ranking and triage by computing means using the sensitivity values to generate the salient hyper-parameters and the fixed hyper-parameter values.

17. The hyper-parameter setup recipe generation method of claim 15, wherein the deep quantifier generation comprises the steps of:
a) performing a salient models generation by computing means using the application-specific learning images, the application-specific truth data and the salient hyper-parameters to generate salient models;
b) performing a salient models application by computing means using the salient models and the application-specific learning images to generate salient model result data; and
c) performing a deep quantification learning by computing means using the salient model result data and the application-specific truth data to generate the deep quantifier generator and the deep quantifier data.

18. The computerized hyper-parameter setup recipe generation method of claim 15, wherein the hyper-parameter setup recipe sets up hyper-parameters that are selected from a group consisting of (1) pre-processing parameters, (2) model architecture parameters, and (3) learning parameters.
